(19) United States
(12) Patent Application Publication
(10) Pub. No.: US 2017/0272524 A1
(43) Pub. Date: Sep. 21, 2017

(54) System and Method for Implementing Device Identification Addresses to Resist Tracking

(71) Applicant: Jonathan James Valliere, STUART, FL (US)

(72) Inventor: Jonathan James Valliere, STUART, FL (US)

(21) Appl. No.: 15/497,459

(22) Filed: Apr. 26, 2017

Related U.S. Application Data
(62) Division of application No. 14/292,808, filed on May 30, 2014.

(51) Int. Cl. H04L 29/08; H04L 29/12

(52) U.S. Cl. CPC H04L 67/18; H04L 61/609; H04L 61/2007

(57) ABSTRACT

A system and method for altering a device identification address in response to various criteria to hinder tacking of the device location. One version of the system uses the physical location of the device as criteria for manipulating the device address in locations that are not recognizable by stored location information and returning the identification address to a preset address in locations that are recognizable. A second version of the invention uses a pair of identification addresses which when recognized together provide a basis for using a given identification address and when not paired together actuates a different identification address to defeat tracking systems.

### AREA OF THE INVENTION

The present invention generally relates to the area of computer-based wireless communications. The invention provides means to communicate with other wireless devices in a way that malicious devices cannot track the device while in range.

### BACKGROUND OF THE INVENTION

Wireless communication devices are everywhere. Today devices such as cell phones, bluetooth accessories, laptops, cellular-wifi access points, and automobiles are connected or have the ability to communicate wirelessly.

By design, wireless communication protocols contain information that is intended to be globally unique in order for a communication to be accepted by a local device. While such protocols are at the foundation of computer communications, they necessarily include device address identifiers that make passive tracking relatively simple, which in turn makes an invasion of user privacy a frightening reality. These address identifiers, regardless of the format they assume, can be readily understood by receptor devices that can not only tell the current location of a device user, but where the user has been in the past, and coupled with other data, where the user lives.

In our rapidly accelerating technological world, individual steps must be taken to keep pace with the tracking of individuals and the resulting loss of privacy and personal security.

### SUMMARY OF THE INVENTION

This invention provides solutions to modify the standard device identification procedures, used in computer networks to resist tracking while maintaining compatibility with existing systems. This invention includes procedures to modify address identifiers including source and destination address pairing and location-based security zones which determine when to implement source address modification. These inventions are designed to provide location privacy for mobile devices.

### BRIEF DESCRIPTION OF THE DRAWINGS

FIG. 1 illustrates a flow-chart for modifying a device identification address when the device location has changed.

FIG. 2 illustrates a flow-chart for modifying a device identification address in accordance with the detection or absence of stored remote and local address pairs.

### DETAILED DESCRIPTION OF THE DRAWINGS

As described herein; a “device identification address”, further referenced as DA, is a numerical string used to identify one communication device from another. This address can be of either physical or logical. In computing, the physical address is commonly implemented as “media access control (MAC)” or as “extended unique identifier (EUI)” addresses. In computing, the logical address is commonly implemented as “internet protocol (IP)” addresses. All networked communication occurs over “media” which consists of wireless and/or wired signals. In computer communications, these addresses are the primary means to identify if a piece of information is meant for one device as opposed to another.

This invention describes a set of procedures for manipulating a DA (or list of DA if supported by the device). The method of setting a DA, itself, is well understood in the “area of the invention”.

As further described herein, these procedures can be used to implement tracking resistant wireless communications.

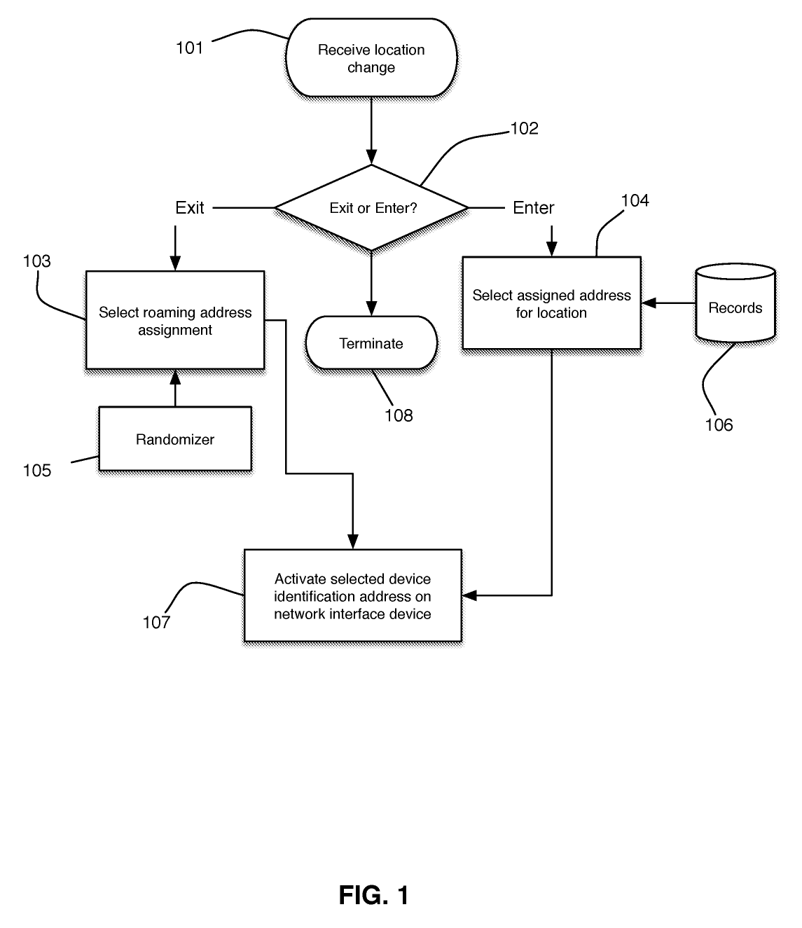

FIG. 1 illustrates a flow-chart to enable tracking protection by modifying a DA when the device location has changed. This is an important scenario because it is useful to disable tracking protection when the device is in a certain physical location, such as work or home.

The workflow in FIG. 1 begins with an abstraction of sensory hardware/software to determine when and how the device is moving as 101. This could be an abstraction of global positioning system (GPS), device accelerometer, wireless device availability, or any other type of location type sensory available to the device. When the sensory trigger occurs in 101, the type of sensory event must be determined in 102. Depending on the event there are three (3) possible actions.

If the sensory event from 101 is determined to represent an “entrance” to a location by 102 then the system proceeds to 104 where the DA for the given location is selected from list 106. The DA is then utilized in 107 to configure the network interface device.

If the sensory event from 101 is determined to represent an “exit” of a location by 102 then the system proceeds to 103 where a new roaming DA is generated by the generating means 105 and utilized in 107 to configure the network interface device.

If the sensory event from 101 is determined to not represent “entrance” or “exit” then no other actions are to be preformed as shown in 108.

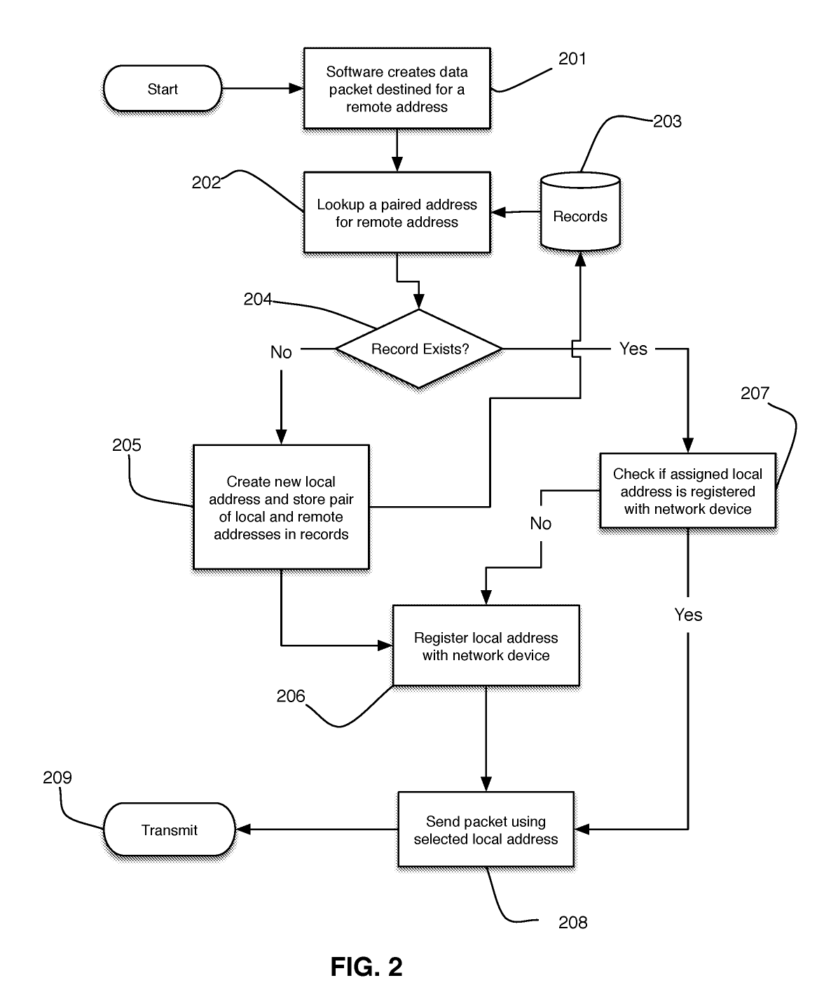

FIG. 2 illustrates a flow-chart wherein modifying a DA does not require any sensory hardware/software. FIG. 2 illustrates a system which utilizes a unique local DA for every remote DA.

When attempting to communicate, the software creates a data packet destined for a remote address 201. At this point the system determines how to identify itself. After the intention to communicate 201; the software looks in a record means 203 to determine if a DA pair exists which includes the DA for the specific remote device to which communication is intended.

If such a DA pair exists in 203 as requested by 202 a decision 204 is made to determine the next action. The local DA of the detected pair is then checked in 207 to see if it currently is registered with the network device. If the local DA is currently so registered then no other action is preformed, and the data packet from 201 is sent to the network device via 208 and then to the media in 209.

If no required DA pair exists in 203 as determined by 204 then the software proceeds to 205 where a new local DA is generated and stored in 203 for use for the next time 201 is invoked. The newly generated local DA, is then registered with the network device via 206. The data packet from 201 is sent to the network device via 208 and then to the media 209.

Optionally, the records in 203 can be extended to provide time to live (TTL) parameters which will cause a pair of DAs to be ineffective after a given amount of time. This could be utilized to provide increased security when visiting the same location on repeated occasions.

1-20. (canceled)

21. A computing device comprising:
a central processing unit for carrying out the instructions of a computer program,
a primary memory unit for supplying instructions and data to said central processing unit,
a network interface means for communicating with a device having a remote identification address,
retention means for retaining at least one pair of identification addresses, one of said pair being a local address associated with said computing device and the other of said pair being an address associated with a remote device,
selection means for selecting a remote identification address,
look up means to determine whether a remote identification address selected by said selection means is an address retained in said retention means,
switching means having a first output activated by a determination of said look up means that said selected remote identification address is an address retained in said retention means,
said switching means having a second output activated by a determination of said look up means that said selected remote identification address is not an address retained in said retention means,
means for configuring said network interface means with a given local address when said first output of said switching means is activated,
an identification address generating means for generating multiple identification addresses,
means for configuring said network interface means with an output of said identification generating means when said second output of said switching means is activated,
whereby said network interface means is configured with a given local identification address when a remote identification address is recognized by said look up means and is configured with a different local identification address derived from said identification address generating means when said look up means fails to recognize a remote identification address.

22. A computing device in accordance with claim 21 wherein:
said look up means includes means to determines whether a selected remote identification address is associated with a pair of addresses previously retained in said retention means.

23. A computing device in accordance with claim 22 wherein:
said first output of said switching means is activated solely upon a determination by said look up means that the selected remote identification address is associated with a pair of addresses retained in said retention means.

24. A computing device in accordance with claim 23 wherein:
said second output of said switching means is activated solely upon a determination by said look up means that the selected remote identification address is not associated with a pair of addresses retained in said retention means.

25. A computing device comprising:
a central processing unit for carrying out the instructions of a computer program,
a primary memory unit for supplying instructions and data to said central processing unit,
a network interface means for communicating with a remote device having a remote identification address,
an operating system capable of defining a local identification address for said network interface means,
means for retaining and retrieving a pair of identification addresses wherein one address of said pair is a remote device address and the other address of said pair is a local address said computing device utilizes when communicating with said remote device,
means for configuring said network interface means with said retained local identification address associated with said pair of identification addresses when said computing device is attempting to communicate with said remote device,
whereby said computing device is caused to have a local address determined by a pair of addresses retained in said retention and retrieving means.

26. A. computing device in accordance with claim 25 including:
means for generating and selecting random local identification addresses,
means for randomly configuring said network interface means with one of said random addresses when said computing device is attempting to communicate with a remote device having an identification address not retained in said retention and retrieving means,
whereby said computing device is caused to have a local identification address that changes upon attempting to communicate with remote devices having identification addresses not retained in said retention and retrieving means.

27. A computing device in accordance with claim 26 including:
means for recoding in said retention and retrieving means a new pair of identification addresses generated each time said computing device attempts to communicate with a remote device having an address not previously recorded in said retention and retrieving means,
whereby said retention and retrieving means is supplemented with a new pair of identification addresses upon said computing device attempting to communicate with a remote device having an address not previously recorded therein.

28. A. method of inhibiting tracking of a computing device having a network interface means comprising the steps of:
creating a first identifying local address for said computing device,
retaining the identifying address of a remote device to which said computing device is attempting to communicate,
linking said remote identification address with said first local address of said computing device as a pair of addresses and retaining said linked pair of addresses,
configuring said network interface means with said first identifying local address under a first criteria related to said linked pair of addresses,
creating a second identifying local address for said computing device,
configuring said network interface means with said second identifying local address under a second criteria related to said linked pair of addresses,
whereby said computing device is caused do have a variable identifying address to inhibit tracking of said computing device.

29. A method of inhibiting tracking of a computing device in accordance with claim 28 including the steps of:
determining whether or not the identifying address of a remote device to which said computing device is attempting to communicate is one of said linked pair of addresses,
utilizing a determination that the identifying address of said remote device is one of said linked pair of addresses as said first criteria,
utilizing a determination that the identifying address of said remote device is not one of said linked pair of addresses as said second criteria,
whereby said computing device is caused to have a local identification address that varies depending on the availability of retained address information of a remote device to which the computing device is attempting to communicate.
